(19) United States
(12) Patent Application Publication
(10) Pub. No.: US 2017/0201302 A1
(43) Pub. Date: Jul. 13, 2017

(54) WIRELESS TRANSMISSION DEVICE AND WIRELESS TRANSMISSION METHOD

(71) Applicant: NEC Corporation, Tokyo (JP)

(72) Inventors: Tomoya KANEKO, Tokyo (JP); Kazumi SHIIKUMA, Tokyo (JP)

(73) Assignee: NEC Corporation, Tokyo (JP)

(21) Appl. No.: 15/327,944

(22) PCT Filed: Jun. 9, 2015
(86) PCT No.: PCT/JP2015/002874

§ 371 Date: Jan. 20, 2017

(30) Foreign Application Priority Data
Jul. 22, 2014 (JP) 2014-148697

(51) Int. Cl. H04B 7/06; H04L 27/36; H04B 1/04

(52) U.S. Cl. CPC H04B 7/06; H04B 1/04; H04L 27/36

(57) ABSTRACT

A wireless transmission device (1) is provided with: a signal conversion unit (20) which converts a baseband signal to a high frequency signal; multiple quadrature modulators (11_1-11_n) which modulate the high frequency signal to multiple high-frequency transmission signals (RFb1-RFbn) based on multiple control voltages (CNT1-CNTn); and multiple antenna elements (12_1-12_n) which emit the multiple transmission signals (RFb1-RFbn) into air.

### TECHNICAL FIELD

The present invention relates to a wireless transmission device and a wireless transmission method, and particularly, relates to a wireless transmission device and a wireless transmission method suitable for reducing a circuit scale.

### BACKGROUND ART

A multiple-input multiple-output (MIMO) communication technique is known as a communication technique for enhancing a communication speed. A wireless transmission device employing MIMO converts signal data into a plurality of high-frequency transmission signals, and wirelessly transmits the plurality of transmission signals respectively from a plurality of antenna elements forming an antenna array. This increases an amount of simultaneously transmittable data, and thus, a communication speed can be improved.

At this time, the wireless transmission device controls corresponding phases and amplitudes of the plurality of transmission signals to be substantially equal to one another at an initial state (i.e., initially aligns the signals). Further, when employing a beamforming technique, the wireless transmission device provides radio waves with directivity through the control of the corresponding phases and amplitudes of the plurality of transmission signals. This can improve a reutilization rate of radio waves within a certain space and prevent unnecessary interference, and thus, utilization efficiency and quality of radio waves can be improved.

Related arts are disclosed in NPL (Non Patent Literature) 1 and PTL (Patent Literature) 1.

NPL 1 discloses a configuration that includes a plurality of variable phase shifters and a plurality of amplitude adjusters respectively controlling phases and amplitudes of a plurality of transmission signals.

In addition, PTL 1 discloses a wireless transmission device that corrects an input of a quadrature modulator for an appropriate range and allows appropriate operation of the quadrature modulator.

A wireless transmission device has recently been desired to have a further improved communication speed as well as further improved utilization efficiency and quality of radio waves by employing MIMO using multiple antenna elements as many as over several tens to hundreds, for example, and a beamforming technique. Herein, MIMO using multiple antenna elements is specifically called as Massive MIMO.

### CITATION LIST

### Patent Literature

Japanese Unexamined Patent Application Publication No. H10-270929

### Non Patent Literature

NPL 1 Pekka Salonen et al, “Analysis and Development of 2.45 GHz Phase Shifters for Adaptive Antennas”, IEEE, 2002, pp159-163.

### SUMMARY OF INVENTION

### Technical Problem

Since the configuration disclosed in NPL 1 requires providing a variable phase shifter and an amplitude adjuster for each of antenna elements, the greater the number of the antenna elements is, the greater the numbers of the variable phase shifters and the amplitude adjusters are. Accordingly, the configuration disclosed in NPL 1 has a problem that a circuit scale increases.

The present invention has been made in order to solve such a problem, and an object of the present invention is to provide a wireless transmission device and a wireless transmission method, in which a circuit scale can be reduced by including a plurality of quadrature modulators for controlling corresponding phases and amplitudes of a plurality of transmission signals wirelessly transmitted via a plurality of antenna elements.

### Solution to Problem

According to one example embodiment, a wireless transmission device includes: a signal conversion unit for converting a baseband signal into a high frequency signal; a plurality of quadrature modulators for respectively modulating the high frequency signal to a plurality of high-frequency transmission signals based on a plurality of control voltages; and a plurality of antenna elements for respectively emitting the plurality of transmission signals into air.

According to one example embodiment, a wireless transmission method includes: converting a baseband signal into a high frequency signal; respectively modulating, by using a plurality of quadrature modulators, the high frequency signal to a plurality of high-frequency transmission signals based on a plurality of control voltages; and respectively emitting the plurality of transmission signals into air via a plurality of antenna elements.

### Advantageous Effects of Invention

The one example embodiment makes it possible to provide a wireless transmission device and a wireless transmission method, in which a circuit scale can be reduced by including a plurality of quadrature modulators for controlling corresponding phases and amplitudes of a plurality of transmission signals wirelessly transmitted via a plurality of antenna elements.

### BRIEF DESCRIPTION OF DRAWINGS

FIG. 1 is a block diagram illustrating an overview of a wireless transmission device according to a first example embodiment.

FIG. 2 is a block diagram illustrating a first specific configuration of a quadrature modulator provided in the wireless transmission device illustrated in FIG. 1.

FIG. 3 is a diagram illustrating an operation of the quadrature modulator illustrated in FIG. 2.

FIG. 4 is a block diagram illustrating a second specific configuration of the quadrature modulator provided in the wireless transmission device illustrated in FIG. 1.

FIG. 5 is a block diagram illustrating a first specific configuration of the wireless transmission device illustrated in FIG. 1.

FIG. 6 is a block diagram illustrating a second specific configuration of the wireless transmission device illustrated in FIG. 1. FIG. 7 is a block diagram illustrating a third specific configuration of the wireless transmission device illustrated in FIG. 1.

### DESCRIPTION OF EMBODIMENTS

In the following, an example embodiment is described with reference to the drawings. Note that the technical scope of the example embodiment should not be narrowly interpreted on the ground of the description of drawings, as the drawings are for simplicity. In addition, the same reference signs are assigned to the same components, and repeated description is omitted.

The following example embodiment is described by being divided into a plurality of sections or example embodiments as needed for convenience. However, except as clearly indicated in specific, the plurality of sections or example embodiments are not irrelevant to one another but rather in a relationship of one being a modification example, an application example, a detailed description, a supplemental description, and the like of a part or all of another one. In addition, when the number or the like of the components (including a number, a numerical value, an amount, a range, and the like) is referred to in the following example embodiment, the number is not limited to a particular number but rather may be a number equal to or more/less than the particular number, except for the cases where clearly indicated in specific, apparently limited to the particular number in principle, and the like.

Further, the components (including operation steps and the like) in the following example embodiment are not necessarily essential, except for the cases where clearly indicated in specific, considered apparently essential in principle, and the like. Likewise, when a shape, a positional relationship, or the like of the components or the like is referred to in the following example embodiment, it is assumed that the shape or the like includes a shape substantially approximate or similar thereto, except for the cases where clearly indicated in specific, apparently not conceivable in principle, and the like. The same applies to the above-described number or the like (including, a number, a numerical value, an amount, a range, and the like).

### Example Embodiment 1

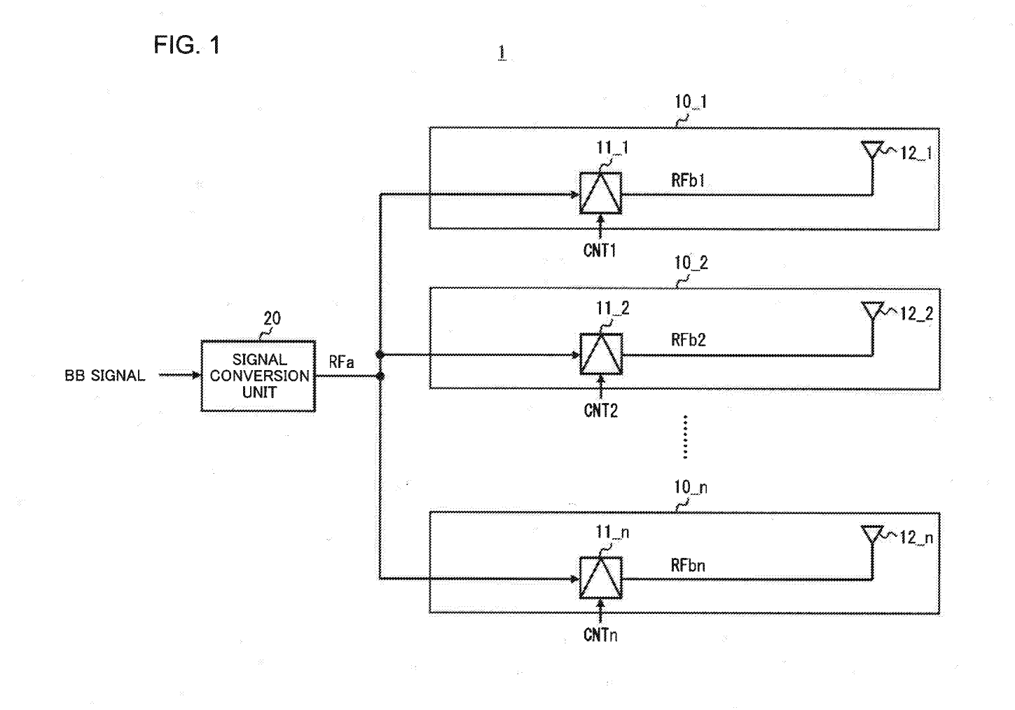

FIG. 1 is a block diagram illustrating an overview of a wireless transmission device 1 according to a first example embodiment. The wireless transmission device 1 according to the present example embodiment is, for example, a mobile telephone base station (particularly, a base station for a 5th generation mobile telephone) employing Massive MIMO and a beamforming technique, and includes a plurality of quadrature modulators for controlling corresponding phases and amplitudes of a plurality of transmission signals wirelessly transmitted via a plurality of antenna elements forming an array antenna. Accordingly, the wireless transmission device 1 can reduce a circuit scale therein. Note that the present example embodiment employs an active antenna system (AAS) achieving a higher efficiency with a simple configuration in which an antenna array and a wireless device are integrated as one body. In the following, a specific description is given.

As illustrated in FIG. 1, the wireless transmission device 1 includes at least front-end (FE) units 10_1 to 10_n (where n is an integer of 2 or greater) and a signal conversion unit 20. The FE units 10_1 to 10_n respectively include a plurality of quadrature modulators 11_1 to 11_n, and a plurality of antenna elements 12_1 to 12_n forming an antenna array. FIG. 1 illustrates only a part of what is called an extended wireless unit.

The signal conversion unit 20 converts a baseband signal (BB signal) into a high frequency signal RFa. A specific configuration of the signal conversion unit 20 will be described later in detail.

The quadrature modulators 11_1 to 11_n respectively modulate the high frequency signal RFa output from the signal conversion unit 20 to high-frequency transmission signals RFb1 to RFbn having phases and amplitudes corresponding to control voltages CNT1 to CNTn. Although not illustrated, note that the wireless transmission device 1 is provided with a control unit for generating the control voltages CNT1 to CNTn.

For example, the quadrature modulators 11_1 to 11_n can initially align the phases and amplitudes of the transmission signals RFb1 to RFbn by respectively adjusting the control voltages CNT1 to CNTn. Further, when employing a beamforming technique, the quadrature modulators 11_1 to 11_n can give radio waves directivity through the control of the phases and amplitudes of the transmission signals RFb1 to RFbn by respectively adjusting the control voltages CNT1 to CNTn.

(First Specific Configuration of Quadrature Modulators 11_1 to 11_n)

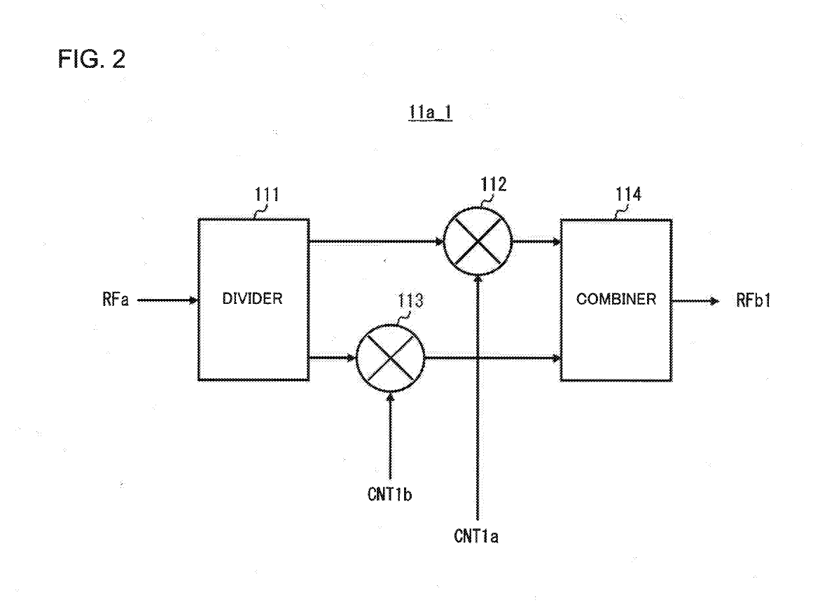

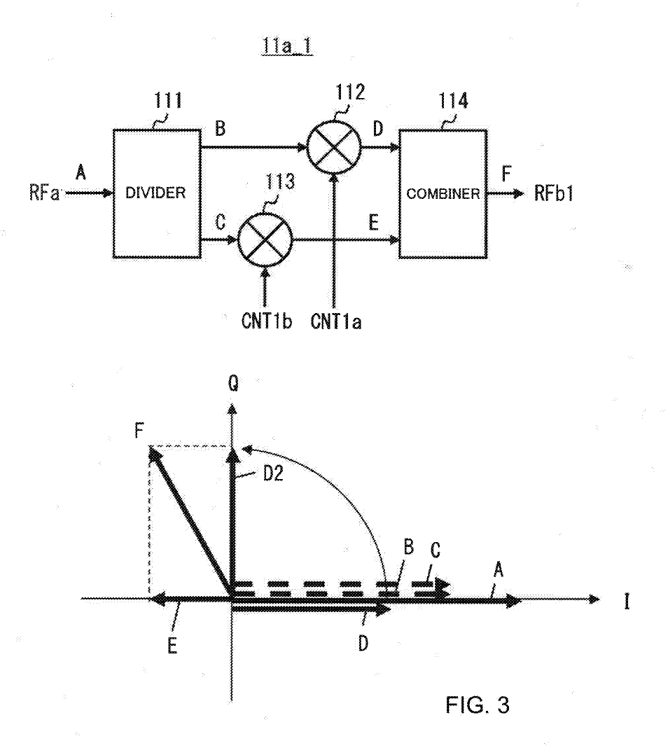

FIG. 2 is a block diagram illustrating a first specific configuration of the quadrature modulator 11_1 as a quadrature modulator 11a_1. FIG. 3 is a diagram illustrating an operation of the quadrature modulator 11a_1. Note that configurations of the quadrature modulators 11_2 to 11_n are the same as that of the quadrature modulator 11_1, and thus, description therefor is omitted.

As illustrated in FIG. 2, the quadrature modulator 11a_1 includes a divider 111, mixers 112 and 113, and a combiner 114. In the present example, a control voltage CNT1 consists of a first voltage CNT1a and a second voltage CNT1b.

The divider 111 divides, for example, a high frequency signal RFa (a signal A in FIG. 3) output from the signal conversion unit 20 into in-phase first and second divided signals (signals B and C in FIG. 3). The mixer 112 multiplies the first divided signal by the first voltage CNT1a, and outputs a signal (a signal D in FIG. 3). The mixer 113 multiplies the second divided signal by the second voltage CNT1b, and outputs a signal (a signal E in FIG. 3). The combiner 114 shifts a phase of the output signal of the mixer 112 by 90° with respect to a phase of the output signal of the mixer 113, and thereafter, combines the 90° phase-shifted output signal (a signal D2 in FIG. 3) of the mixer 112 with the output signal (the signal E in FIG. 3) of the mixer 113, and outputs a transmission signal RFb1 (a signal F in FIG. 3). Note that, for the purpose of illustrating a basic operation of the quadrature modulator 11a_1, phases of the signals are depicted in FIG. 3 with reference to a horizontal axis, and phase rotation generated in common with respective paths of the first divided signal and the second divided signal is omitted.

In the above, description has been given about a case in which the divider 111 divides a high frequency signal RFa into in-phase first and second divided signals, and the combiner 114 combines a signal obtained by 90° shifting a phase of an output signal of the mixer 112 with an output signal of the mixer 113. However, the present example is not limited thereto. The present example may be configured in such a way that the divider 111 divides a high frequency signal RFa into first and second divided signals having phases different by 90° , and the combiner 114 combines a phase of an output signal of the mixer 112 with a phase of an output signal of the mixer 113 in phase.

(Second Specific Configuration of Quadrature Modulators 11_1 to 11_n)

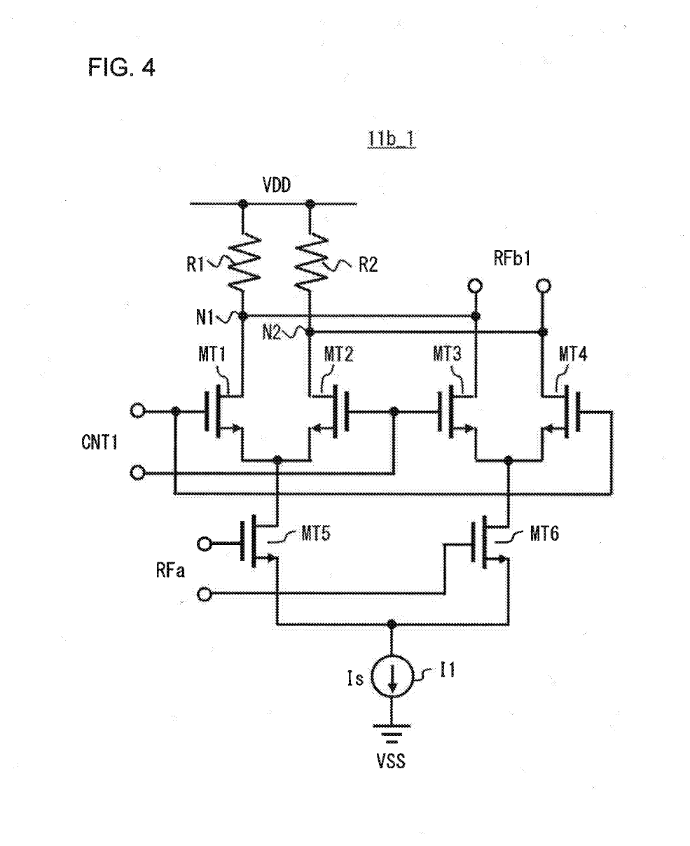

FIG. 4 is a block diagram illustrating a second specific configuration of the quadrature modulator 11_1 as a quadrature modulator 11b_1. Note that configurations of the quadrature modulators 11_2 to 11_n are the same as that of the quadrature modulator 11_1, and thus, description therefor is omitted.

As illustrated in FIG. 4, the quadrature modulator 11b_1 includes resistive elements R1 and R2, transistors MT1 to MT6, and a constant current source I1. In the present example, the transistors MT1 to MT6 are all N-channel MOS transistors.

One end of the resistive element R1 is connected to a power source voltage terminal to which a power source voltage VDD is supplied (hereinafter, referred to as a power source voltage terminal VDD), and another end of the resistive element R1 is connected to a node N1. One end of the resistive element R2 is connected to the power source voltage terminal VDD, and another end of the resistive element R2 is connected to a node N2.

Regarding the transistor MT1, the source is connected to a drain of the transistor MT5, the drain is connected to the node N1, and the gate is supplied with a control voltage CNT1 (more specifically, one of differential signals constituting the control voltage CNT1). Regarding the transistor MT2, the source is connected to the drain of the transistor MT5, the drain is connected to the node N2, and the gate is supplied with the control voltage CNT1 (more specifically, the other of the differential signals constituting the control voltage CNT1).

Regarding the transistor MT3, the source is connected to a drain of the transistor MT6, the drain is connected to the node N1, and the gate is supplied with the control voltage CNT1 (more specifically, the other of the differential signals constituting the control voltage CNT1). Regarding the transistor MT4, the source is connected to the drain of the transistor MT6, the drain is connected to the node N2, and the gate is supplied with the control voltage CNT1 (more specifically, the one of the differential signals constituting the control voltage CNT1).

Regarding the transistor MT5, the source is connected to an input terminal of the constant current source I1, and the gate is supplied with a high frequency signal RFa (more specifically, one of differential signals constituting the high frequency signal RFa). Regarding the transistor MT6, the source is connected to the input terminal of the constant current source I1, and the gate is supplied with the high frequency signal RFa (more specifically, another of the differential signals constituting the high frequency signal RFa). An output terminal of the constant current source I1 is a ground voltage terminal to which a ground voltage VSS is supplied (hereinafter, referred to as a ground voltage terminal VSS). Then, electric potentials of the nodes N1 and N2 are respectively output to outside as transmission signals RFb1 (more specifically, one and another of differential signals constituting the transmission signal RFb1).

In other words, the quadrature modulator 11b_1 has a configuration of what is called a Gilbert cell mixer. Such a configuration facilitates circuit integration, and is hence remarkably effective especially in miniaturization of a wireless transmission device that employs MIMO using multiple antenna elements and a beamforming technique. Note that the quadrature modulator 11b_1 can be modified as appropriate into another configuration with an equivalent function, without limitation to the above-described configuration.

Returning to FIG. 1, the transmission signals RFb1 to RFbn are emitted into air (i.e., wirelessly transmitted) respectively via the antenna elements 12_1 to 12_n .

In this way, the wireless transmission device 1 includes a plurality of quadrature modulators for controlling corresponding phases and amplitudes of a plurality of transmission signals wirelessly transmitted via a plurality of antenna elements. Accordingly, the wireless transmission device 1 does not require providing a plurality of variable phase shifters and a plurality of amplitude adjusters respectively for a plurality of antenna elements, and thus, can prevent an increase in a circuit scale.

(First Specific Configuration of Wireless Transmission Device 1)

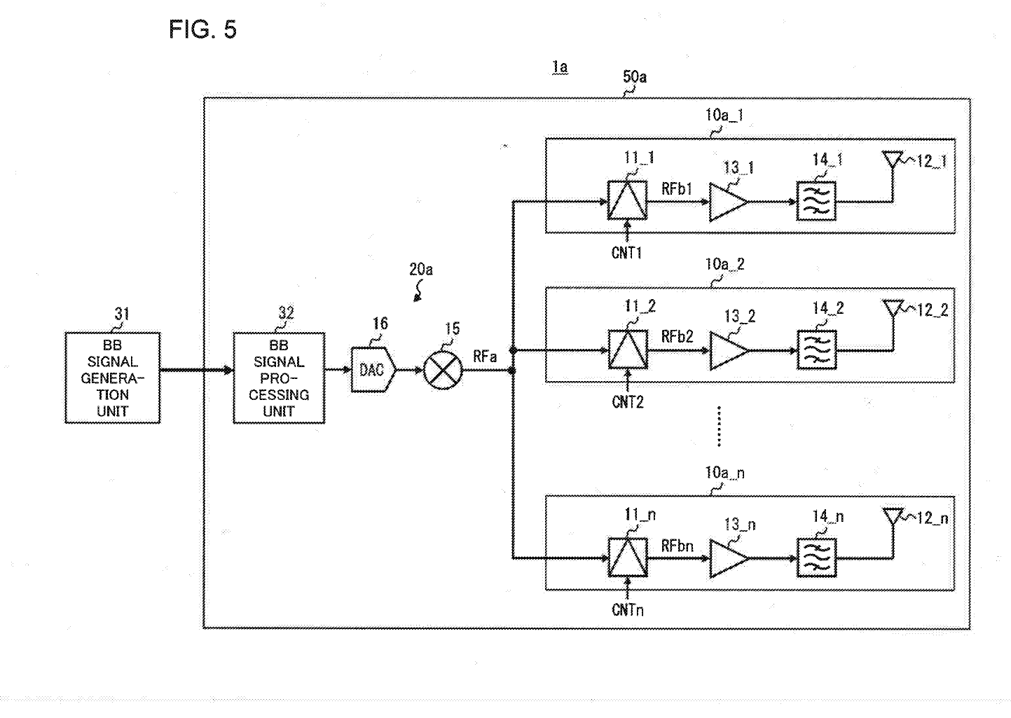

FIG. 5 is a block diagram illustrating a first specific configuration of the wireless transmission device 1 as a wireless transmission device 1a.

As illustrated in FIG. 5, the wireless transmission device 1a includes a baseband signal generation unit (BB signal generation unit) 31, a baseband signal processing unit (BB signal processing unit) 32, a DA converter 16, an upconverter 15, and FE units 10a_1 to 10a_n. The DA converter 16 and the upconverter 15 form a signal conversion unit 20a. The baseband signal processing unit 32, the DA converter 16, the upconverter 15, and the FE units 10a_1 to 10a_n form an extended wireless unit 50a.

Note that the FE units 10a_1 to 10a_n and the signal conversion unit 20a correspond to the FE units 10_1 to 10_n and the signal conversion unit 20, respectively.

The baseband signal generation unit 31 is provided separately from the extended wireless unit 50a, and generates a baseband signal. The baseband signal is supplied to the baseband signal processing unit 32 provided in the extended wireless unit 50a via a signal line such as an optical cable and an Ethernet cable, for example.

The baseband signal processing unit 32 performs processing of converting the baseband signal generated by the baseband signal generation unit 31 into a signal suitable for wireless transmission. More specifically, the baseband signal processing unit 32 demultiplexes the time-division multiplexed baseband signal generated by the baseband signal generation unit 31.

The DA converter 16 converts the baseband signal processed by the baseband signal processing unit 32 into an analog signal. The upconverter 15 frequency-converts the analog signal output from the DA converter 16 into a high frequency signal RFa.

The FE units 10a_1 to 10a_n further include, in addition to quadrature modulators 11_1 to 11_n and antenna elements 12_1 to 12_n, amplifiers 13_1 to 13_n and filters 14_1 to 14_n, respectively.

The quadrature modulators 11_1 to 11_n respectively modulate, as described above, the high frequency signal RFa output from the signal conversion unit 20 to transmission signals RFb1 to RFbn having phases and amplitudes corresponding to control voltages CNT1 to CNTn.

The amplifiers 13_1 to 13_n respectively amplify the transmission signals RFb1 to RFbn to desired voltage levels, and output the signals. The filters 14_1 to 14_n respectively allow to pass only the output signals of the amplifiers 13_1 to 13_n of desired passbands. The transmission signals RFb1 to RFbn having been passed through the amplifiers 13_1 to 13_n are respectively emitted into air via the antenna elements 12_1 to 12_n.

(Second Specific Configuration of Wireless Transmission Device 1)

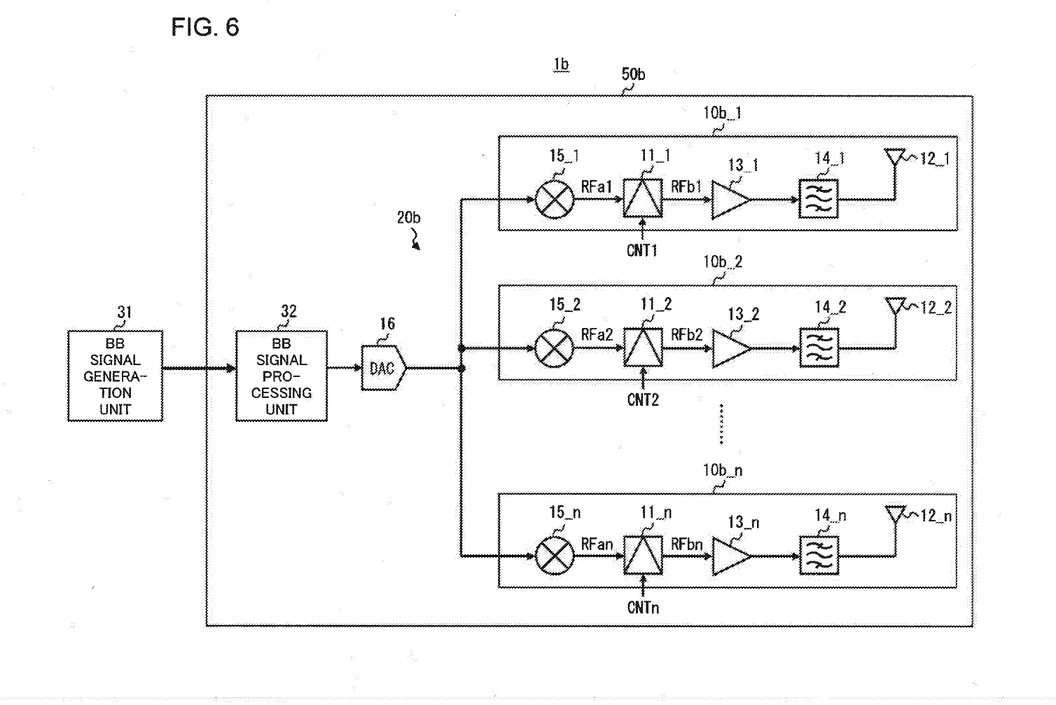

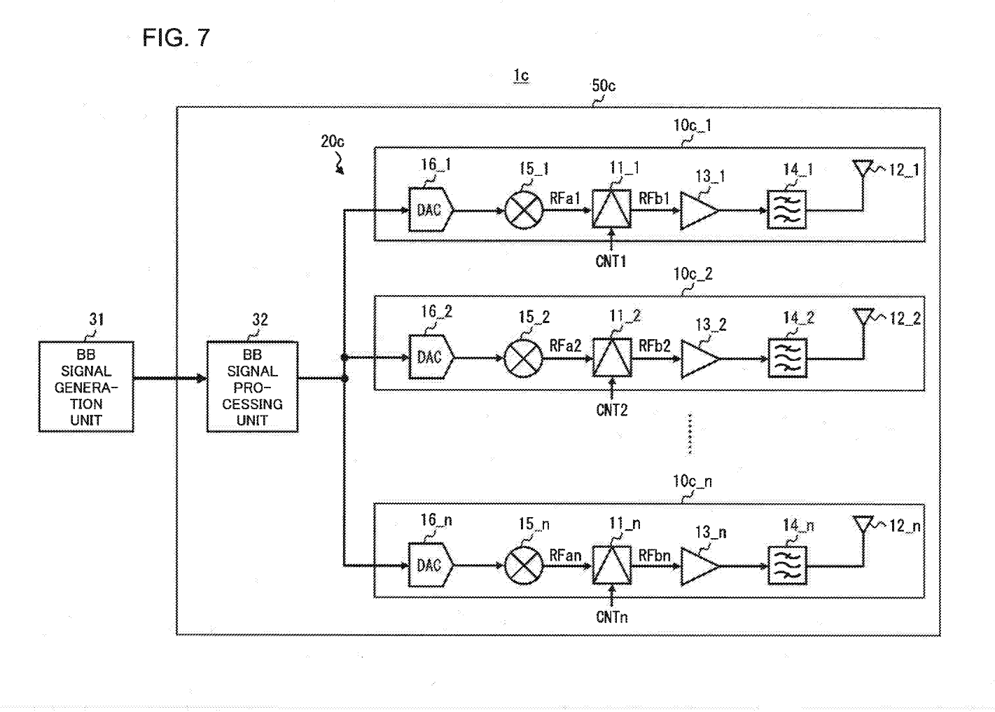

FIG. 6 is a block diagram illustrating a second specific configuration of the wireless transmission device 1 as a wireless transmission device 1b. In comparison with the wireless transmission device 1a, the wireless transmission device 1b includes, instead of the upconverter 15, upconverters 15_1 to 15_n provided in correspondence with antenna elements 12_1 to 12_n. In the following, a specific description is given.

As illustrated in FIG. 6, the wireless transmission device 1b includes a baseband signal generation unit (BB signal generation unit) 31, a baseband signal processing unit (BB signal processing unit) 32, a DA converter 16, and FE units 10b_1 to 10b_n. The FE units 10b_1 to 10b_n correspond to the FE units 10a_1 to 10a_n , and further include the upconverters 15_1 to 15_n, respectively.

Note that the DA converter 16 and the upconverters 15_1 to 15_n form a signal conversion unit 20b. The baseband signal processing unit 32, the DA converter 16, and the FE units 10b_1 to 10b_n form an extended wireless unit 50b.

The upconverters 15_1 to 15_n frequency-convert an analog signal output from the DA converter 16 into high frequency signals RFa1 to RFan.

The quadrature modulators 11_1 to 11_n respectively modulate the high frequency signals RFa1 to RFan to transmission signals RFb1 to RFbn having phases and amplitudes corresponding to control voltages CNT1 to CNTn.

Other configurations of the wireless transmission device 1b are the same as that of the wireless transmission device 1a, and thus, description therefor is omitted.

(Third Specific Configuration of Wireless Transmission Device 1)

FIG. 7 is a block diagram illustrating a third specific configuration of the wireless transmission device 1 as a wireless transmission device 1c. In comparison with the wireless transmission device 1a, the wireless transmission device 1c includes, instead of the upconverter 15, upconverters 15_1 to 15_n provided in correspondence with antenna elements 12_1 to 12_n, and includes, instead of the DA converter 16, DA converters 16_1 to 16_n also provided in correspondence with the antenna elements 12_1 to 12_n. In the following, a specific description is given.

As illustrated in FIG. 7, the wireless transmission device 1c includes a baseband signal processing unit 32 (BB signal generation unit) 31, a baseband signal processing unit (BB signal processing unit) 32, and FE units 10c_1 to 10c_n. The FE units 10c_1 to 10c_n correspond to the FE units 10a_1 to 10a_n , and further include the upconverters 15_1 to 15_n and the DA converters 16_1 to 16_n, respectively.

Note that the DA converters 16_1 to 16_n and the upconverters 15_1 to 15_n form a signal conversion unit 20c. The baseband signal processing unit 32 and the FE units 10c_1 to 10c_n form an extended wireless unit 50c.

The DA converters 16_1 to 16_n each convert a baseband signal processed by the baseband signal processing unit 32 into analog signals. The upconverters 15_1 to 15_n frequency-convert the analog signals output from the DA converters 16_1 to 16_n into high frequency signals RFa1 to RFan, respectively. The quadrature modulators 11_1 to 11_n respectively modulate the high frequency signals RFa1 to RFan to transmission signals RFb1 to RFbn having phases and amplitudes corresponding to control voltages CNT1 to CNTn.

Other configurations of the wireless transmission device 1c are the same as that of the wireless transmission device 1a, and thus, description therefor is omitted.

In the wireless transmission device 1a, the DA converter 16 and the upconverter 15 are provided in common with the plurality of antenna elements 12_1 to 12_n. This can reduce the number of the components. On the other hand, in the wireless transmission device 1c, the plurality of DA converters 16_1 to 16_n and the plurality of upconverters 15_1 to 15_n are provided for the plurality of antenna elements 12_1 to 12_n, respectively. This can prevent an increase in routing of wiring that may be caused when the DA converter 16 and the upconverter 15 are shared.

As described above, the wireless transmission device according to the above-described first example embodiment includes a plurality of quadrature modulators for controlling corresponding phases and amplitudes of a plurality of transmission signals wirelessly transmitted via a plurality of antenna elements. Accordingly, the wireless transmission device according to the above-described first example embodiment can reduce a circuit scale therein.

Difference from Related Art

In the wireless transmission device disclosed in PTL 1, a quadrature modulator merely modulates a baseband signal to an IF signal. On the other hand, in the wireless transmission device according to the above-described first example embodiment, a quadrature modulator modulates a high frequency signal (RFa) to another high frequency signal (RFb1, for example) for the purpose of controlling corresponding phases and amplitudes of a plurality of transmission signals. In other words, the wireless transmission device disclosed in PTL 1 and the wireless transmission device according to the above-described first example embodiment are not only different in structure, but also clearly different in utilization purpose of a quadrature modulator.

Note that, when assuming that corresponding phases and amplitudes of a plurality of transmission signals are attempted to be controlled in advance with the baseband signal generation unit 31, a signal line connecting the baseband signal generation unit 31 with the baseband signal processing unit 32 is required to be capable of transmitting a high-speed and wide-band signal. On the other hand, since such a request is moderate in the wireless transmission device according to the above-described first example embodiment, the wireless transmission device according to the above-described first example embodiment can reduce a circuit scale therein.

Note that the present invention is not limited to the above-described example embodiment, but can be modified as appropriate within the scope not departing from the gist of the present invention.

In the above, the invention of the present application has been described with reference to the example embodiment. However, the invention of the present application is not limited by the above description. Various modifications that can be understood by those skilled in the art can be made to the configurations and details of the invention of the present application within the scope of the invention.

This application is based upon and claims the benefit of priority from Japanese Patent Application No. 2014-148697, filed on Jul. 22, 2014,the disclosure of which is incorporated herein in its entirety.

### REFERENCE SIGNS LIST

Wireless transmission device
1a to 1c Wireless transmission device
10_1 to 10_n FE unit
10a_1 to 10a_n FE unit
10b_1 to 10b_n FE unit
10c_1 to 10c_n FE unit
11_1 to 11_n Quadrature modulator
12_1 to 12_n Antenna element
13_1 to 13_n Amplifier
14_1 to 14_n Filter
15, 15_1 to 15_n Upconverter
16, 16_1 to 16_n DA converter
20 Signal conversion unit
20a to 20c Signal conversion unit
Baseband signal generation unit
Baseband signal processing unit
Extended wireless unit
50a to 50c Extended wireless unit
111 Divider
112 Mixer
113 Mixer
114 Combiner
MT1 to MT6 Transistor
R1, R2 Resistive element
I1 Constant current source

1. A wireless transmission device comprising:
a signal converter for converting a baseband signal into a high frequency signal;
a plurality of quadrature modulators for respectively modulating the high frequency signal to a plurality of high-frequency transmission signals based on a plurality of control voltages; and
a plurality of antenna elements for respectively emitting the plurality of transmission signals into air.

2. The wireless transmission device according to claim 1, further comprising
a controller for generating the plurality of control voltages, wherein
the plurality of antenna elements form an array antenna, and
the plurality of quadrature modulators are provided on a plurality of RF paths for propagating a high-frequency signal to each of the plurality of antenna elements.

3. The wireless transmission device according to claim 1, wherein
each of the quadrature modulators includes:
a divider for dividing the high frequency signal into a first divided signal and a second divided signal;
a first mixer and a second mixer for respectively multiplying the first divided signal and the second divided signal by a first voltage and a second voltage constituting the control voltages; and
a combiner for combining an output signal of the first mixer with an output signal of the second mixer.

4. The wireless transmission device according to claim 1, wherein
each of the quadrature modulators includes a Gilbert cell mixer.

5. The wireless transmission device according to claim 1, wherein
the signal converter includes:
a DA converter for converting the baseband signal into an analog signal; and
an upconverter for frequency-converting the analog signal into the high frequency signal.

6. The wireless transmission device according to claim 1, wherein
the signal converter includes:
a DA converter for converting the baseband signal into an analog signal; and
a plurality of upconverters for respectively frequency-converting the analog signal into a plurality of the high frequency signals, wherein
the plurality of quadrature modulators respectively modulate the plurality of the high frequency signals to the plurality of transmission signals.

7. The wireless transmission device according to claim 1, wherein
the signal converter includes:
a plurality of DA converters for respectively converting the baseband signal into a plurality of analog signals; and
a plurality of upconverters for respectively frequency-converting the plurality of analog signals into a plurality of the high frequency signals, wherein
the plurality of quadrature modulators respectively modulate the plurality of high frequency signals to the plurality of transmission signals.

8. A wireless transmission method comprising:
converting a baseband signal into a high frequency signal;
respectively modulating, by using a plurality of quadrature modulators, the high frequency signal to a plurality of high-frequency transmission signals based on a plurality of control voltages; and
respectively emitting the plurality of transmission signals into air via a plurality of antenna elements.

9. The wireless transmission method according to claim 8, wherein
in each of the quadrature modulators,
the high frequency signal is divided into a first divided signal and a second divided signal,
the first divided signal and the second divided signal are respectively multiplied by a first voltage and a second voltage constituting the control voltages, and
respective results of the multiplication are combined and the transmission signals are output.

10. The wireless transmission method according to claim 8, wherein a Gilbert cell mixer is provided as each of the quadrature modulators.

11. The wireless transmission device according to claim 2, wherein
each of the quadrature modulators includes:
a divider for dividing the high frequency signal into a first divided signal and a second divided signal;
a first mixer and a second mixer for respectively multiplying the first divided signal and the second divided signal by a first voltage and a second voltage constituting the control voltages; and
a combiner for combining an output signal of the first mixer with an output signal of the second mixer.

12. The wireless transmission device according to claim 2, wherein
each of the quadrature modulators includes a Gilbert cell mixer.

13. The wireless transmission device according to claim 2, wherein
the signal converter includes:
a DA converter for converting the baseband signal into an analog signal; and
an upconverter for frequency-converting the analog signal into the high frequency signal.

14. The wireless transmission device according to claim 2, wherein
the signal converter includes:
a DA converter for converting the baseband signal into an analog signal; and
a plurality of upconverters for respectively frequency-converting the analog signal into a plurality of the high frequency signals, wherein
the plurality of quadrature modulators respectively modulate the plurality of the high frequency signals to the plurality of transmission signals.

15. The wireless transmission device according to claim 2, wherein
the signal converter includes:
a plurality of DA converters for respectively converting the baseband signal into a plurality of analog signals; and
a plurality of upconverters for respectively frequency-converting the plurality of analog signals into a plurality of the high frequency signals, wherein
the plurality of quadrature modulators respectively modulate the plurality of high frequency signals to the plurality of transmission signals.

16. The wireless transmission device according to claim 3, wherein
the signal converter includes:
a DA converter for converting the baseband signal into an analog signal; and
an upconverter for frequency-converting the analog signal into the high frequency signal.

17. The wireless transmission device according to claim 3, wherein
the signal converter includes:
a DA converter for converting the baseband signal into an analog signal; and
a plurality of upconverters for respectively frequency-converting the analog signal into a plurality of the high frequency signals, wherein
the plurality of quadrature modulators respectively modulate the plurality of the high frequency signals to the plurality of transmission signals.

18. The wireless transmission device according to claim 3, wherein
the signal converter includes:
a plurality of DA converters for respectively converting the baseband signal into a plurality of analog signals; and
a plurality of upconverters for respectively frequency-converting the plurality of analog signals into a plurality of the high frequency signals, wherein
the plurality of quadrature modulators respectively modulate the plurality of high frequency signals to the plurality of transmission signals.

19. The wireless transmission device according to claim 4, wherein
the signal converter includes:
a DA converter for converting the baseband signal into an analog signal; and
an upconverter for frequency-converting the analog signal into the high frequency signal.

20. The wireless transmission device according to claim 4, wherein
the signal converter includes:
a DA converter for converting the baseband signal into an analog signal; and
a plurality of upconverters for respectively frequency-converting the analog signal into a plurality of the high frequency signals, wherein
the plurality of quadrature modulators respectively modulate the plurality of the high frequency signals to the plurality of transmission signals.

21. The wireless transmission device according to claim 4, wherein
the signal converter includes:
a plurality of DA converters for respectively converting the baseband signal into a plurality of analog signals; and
a plurality of upconverters for respectively frequency-converting the plurality of analog signals into a plurality of the high frequency signals, wherein
the plurality of quadrature modulators respectively modulate the plurality of high frequency signals to the plurality of transmission signals.
